(19) United States
(12) Patent Application Publication
(10) Pub. No.: US 2025/0369933 A1
(43) Pub. Date: Dec. 4, 2025

(54) DILUTION CONTROL FOR FIELD FLOW FRACTIONATION CHANNEL

(71) Applicant: Wyatt Technology, LLC, Goleta, CA (US)

(72) Inventor: Steven P. Trainoff, Santa Barbara, CA (US)

(21) Appl. No.: 19/224,240

(22) Filed: May 30, 2025

Related U.S. Application Data
(60) Provisional application No. 63/654,582, filed on May 31, 2024.

(51) Int. Cl. G01N 30/00

(52) U.S. Cl. CPC G01N 30/0005; G01N 2030/003

(57) ABSTRACT

A field flow fractionator comprises a top plate comprising a channel side, a fitting side, a channel outlet port, and a dilution control module (DCM) port. The DCM port is positioned a predetermined distance from the channel outlet port on the channel side of the top plate. An opening of the DCM port comprises a slot with a height to span a channel from a first edge of the channel to a second edge of the channel and with a width to allow for the distance. A fitting of the DCM port extending through the top plate is positioned at an angle relative to a direction of extension of the top plate to accommodate the predetermined distance.

### RELATED APPLICATIONS

This application claims priority to U.S. provisional patent application No. 63/654,582 filed May 31, 2024 and titled “Dilution Control Port for Field Flow Fractionator,” the contents of which are incorporated by reference in their entirety.

### FIELD

The present disclosure relates to field flow fractionators, and more specifically, optimized dilution control for field flow fractionation.

### BACKGROUND

Field flow fractionation (FFF) systems are commonly used to fractionate particles and molecules by applying a field to a fluid sample in the FFF channel. A fluid sample containing particles or molecules is injected into the FFF channel. A force is applied perpendicular to the flow, concentrating the sample against the accumulation wall at the bottom of the channel. Smaller particles diffuse away from the wall more than larger ones, leading to size-based separation. The sample is extracted through a detector port where it can be analyzed.

For Asymmetric Flow FFF (A4F) systems in particular, separation occurs by solvents passing through a semi-permeable membrane, but the sample is retained. Here, the membrane surface functions as an accumulation wall. However, the detector output may suffer from dilution because the sample-rich layer is at the accumulation wall, while the rest of the channel carries mostly sample-free carrier fluid.

It is desirable for the system to include a dilution control mechanism that removes this excess fluid before the sample reaches the detector, thereby increasing the sample concentration and improving detection quality.

### SUMMARY

In one aspect, a field flow fractionator comprises a top plate comprising a channel side; a fitting side; a channel outlet port; and a dilution control module (DCM) port. The DCM port is positioned a predetermined distance from the channel outlet port on the channel side of the top plate. An opening of the DCM port comprises a slot with a height to span a channel from a first edge of the channel to a second edge of the channel and with a width to allow for the distance. A fitting of the DCM port extending through the top plate is positioned at an angle relative to a direction of extension of the top plate to accommodate the predetermined distance.

In another aspect, a field flow fractionator (FFF) comprising a top plate comprising a stepped barrier; a channel outlet port, wherein an opening of the channel outlet port is positioned on a plane of the stepped barrier; and a dilution control module (DCM) port. At least a portion of an opening of the DCM port is positioned on a plane lower than the plane of the stepped barrier. In another aspect, an apparatus comprises a top plate comprising: a top surface; and a bottom surface. The apparatus further comprises a bottom plate; a FFF channel between the top plate and the bottom plate; a channel outlet port; and a dilution control module (DCM) port. The DCM port is positioned a predetermined distance from the channel outlet port on the channel side of the top plate. An opening of the DCM port comprises a slot with a height to span a channel from a first edge of the channel to a second edge of the channel and with a width to allow for the distance. A fitting of the DCM port extending through the top plate is positioned at an angle relative to a direction of extension of the top plate to accommodate the predetermined distance.

In another aspect, an apparatus comprises a top plate comprising: a top surface; and a bottom surface. The apparatus also comprises a bottom plate; a field flow fractionation channel between the top plate and the bottom plate; a channel outlet port; and a dilution control module (DCM) port, wherein the DCM port is positioned a predetermined distance from the channel outlet port on the channel side of the top plate, wherein an opening of the DCM port comprises a slot with a height to span a channel from a first edge of the channel to a second edge of the channel and with a width to allow for the distance, and wherein a fitting of the DCM port extending through the top plate is positioned at an angle relative to a direction of extension of the top plate to accommodate the predetermined distance.

### BRIEF DESCRIPTION OF THE DRAWINGS

FIG. 1 is a schematic illustration of an output region of a FFF channel, in which embodiments of the present inventive concept can be practiced.

FIG. 2 is a graph illustrating detector signal results from individual experimental separations, or runs, of a sample through the FFF system of FIG. 1.

FIG. 3 is a graph illustrating a quantitative analysis of the FFF runs presented in FIG. 2 including a normalized peak area plotted as a function of the concentration enhancement (CE) ratio.

FIG. 4 is a graph illustrating the relative sample mass recovery from each run shown in FIGS. 2 and 3 at different CE ratios, normalized to a sample mass recovered at CE=1.

FIG. 5 is a graph illustrating a set of normalized Chromatograms across different CE ratios.

FIG. 6 is a graph illustrating a plot of a maximum concentration for each CE ratio of FIGS. 2-5.

FIG. 7 is a computational fluid dynamics (CFD) simulation illustrating how sample and solvent flow through the output region of a field-flow fractionation (FFF) channel when using a 5:1 split ratio between the DCM port and the detector outlet port of the FFF channel shown in FIG.

FIG. 8 depicts an apparatus in accordance with some embodiments.

FIG. 9 is a CFD simulation taken of the apparatus of FIG. 8 having a barrier between the DCM port and detector outlet port, in accordance with some embodiments.

FIG. 10 is a cross-sectional view of an apparatus, in accordance with some embodiments.

FIG. 11 is a graph shows a comparison of the maximum normalized concentration detected for different Concentration Enhancement (CE) ratios using the apparatus shown in FIG. 10 as compared to a conventional fixed height (FH) channel configuration.

FIG. 12 is a graph illustrating a quantitative analysis of the FFF runs presented in FIGS. 2-6 including a normalized peak area plotted as a function of the concentration enhancement (CE) ratio compared to those of the apparatus of FIG. 10.

FIG. 13 is a perspective view of a DCM comprising a flat cone, in accordance with some embodiments.

FIGS. 14A and 14B are cross-sectional views of an apparatus having a stepped barrier, in accordance with some embodiments.

FIG. 15 is a perspective view of the apparatus of FIGS. 14A and 14B.

### DETAILED DESCRIPTION

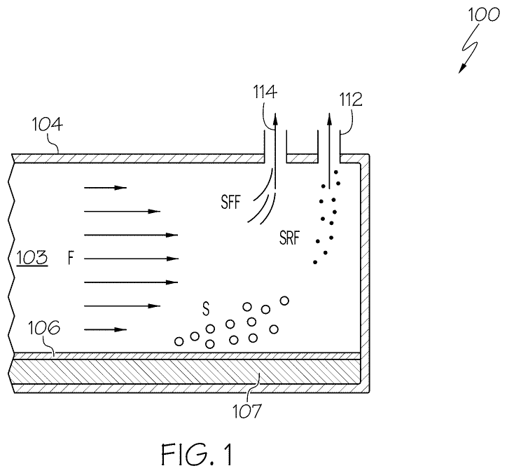

FIG. 1 is a schematic illustration of an output region of a FFF channel, in which embodiments of the present inventive concept can be practiced. The FFF channel is part of a separation mechanism 100 constructed and arranged separate and characterize nanoparticles and microparticles in a sample. In some embodiments, separation mechanism 100 can perform an asymmetric-flow field-flow fractionation (AF4) separation process or the like.

During fractionation, a solvent (F) is injected into a channel inlet port (not shown). A source of unseparated sample (S) is injected into a sample inject port (not shown). The separation mechanism 100 includes a channel 103 between a top plate 104 and a semi-permeable membrane 106 supported by a frit 107. The membrane 106 is permeable to solvent but not to analytes. The sample is concentrated against an accumulation wall, i.e., a top surface of the membrane 106. It fractionates as it travels down the channel until it is extracted from the channel 103 through a detector outlet port 112, which is positioned on the channel side of the top plate 104, at which time the sample is diluted by sample-free carrier fluid that fills the rest of the channel 103. This results in a detector stream that is highly diluted compared to the sample that was concentrated along the accumulation wall 106. A dilution control module (DCM) port 114 is co-located with the detector outlet port 112 at the top plate 104.

During a separation operation, the sample components accumulate near the accumulation wall 106 at the bottom of the channel 103. The upper region of the channel 103 contains carrier fluid (F) with little or no sample. At the channel outlet, the flow is divided where the DCM port 114 draws off the upper (sample-free) fluid (SFF) and the detector outlet port 112 collects the lower (sample-rich) portion (SRF). By adjusting the ratio of flows between the DCM port 114 and detector outlet port 112, users can control the degree of dilution, referred to as a concentration enhancement factor (CE) while minimizing sample loss and peak broadening.

The higher concentration improves analysis instruments signal-to-noise ratio. Moreover, by changing the ratio of flows that exit through the DCM port to the sample port, one can adjust the concentration enhancement. The CE is defined as CE=F_{channel}/Fₒᵤₜₗₑₜ, where F_{channel} is the flow down the channel, and Fₒᵤₜₗₑₜ is the flow that goes to the detector chain. The DCM flow is the difference between these, i.e. F_{DCM}=F_{channel}−Fₒᵤₜₗₑₜ, so one can also write that

$$CE = \frac{{F}_{DCM}}{{F}_{channel}} + 1 .$$

For example, if the channel flow is split 1:1 between the DCM and outlet ports, the sample concentration is enhanced by a factor of 2. If the split is 2:1, the concentration enhancement is 3.

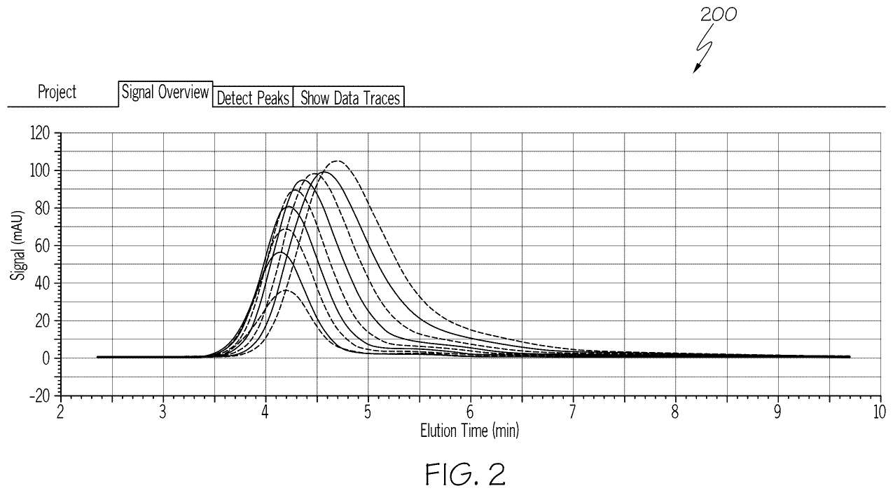

The performance can be characterized by way of a simple experiment, the results from the individual experimental separations, or runs, of which are shown in FIG. 2, which illustrates the trade-off between CE and peak sharpness.

By way of example, the graph 200 in FIG. 2 shows a series of replicate fractionations of Bovine Serum Albumen (BSA) with a constant channel flow but different CE ratios, or split ratios between the DCM port 114 and the detector outlet port 112, applied. In FIG. 2, the Y-axis shows the UV absorption signal (in milli-absorbance units, mAU) indicating the concentration of BSA detected. The X-axis shows the elution time, or how long the sample took to exit the FFF channel. The multiple curves represent replicate runs at different CE ratios (e.g., CE=2, 3, 4, . . . 10). Each curve corresponds to a separation under the same conditions, except for the ratio of flow split between the DCM port and the detector outlet.

As CE increases, the UV signal becomes stronger indicating that a more concentrated sample reaches the detector. This illustrates that the DCM port 114 is effectively removing dilution fluid and enhancing the signal. However, at the highest CE ratios (e.g., CE=10), the peak becomes wider and flatter. This indicates loss of resolution and peak dispersion due to diffusion or shear effects. The higher CE runs tend to elute later, meaning the peak shifts to the right along the Y-axis. This suggests longer transit time and more mixing between the DCM and outlet ports.

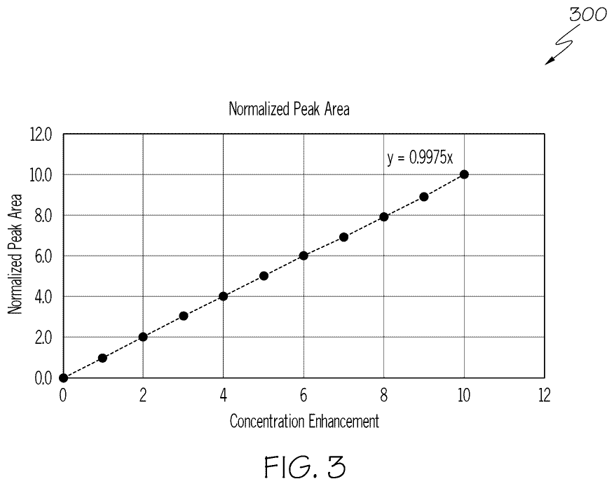

When normalized by the area of the no concentration enhancement signal, (CE=1, not shown), the resulting ratio is dimensionless. The results are shown in the graph 300 in FIG. 3, which shows that the area increases directly proportional to the applied concentration ratio. In particular, the graph 300 plots the normalized peak area as a function of the CE ratio. The normalized peak area (Y-axis) is the integrated UV detector signal (area under the peak) for each run, divided by the peak area at CE=1 (not shown in FIG. 2, but used as the baseline). The CE ratio (X-axis) is the factor by which flow is split between the DCM port and the detector outlet (e.g., CE=2, 3, 4, 10).

As shown in the graph 300 in FIG. 3, the normalized peak area increases linearly with CE. The peak area should be proportional to product of the mass and the CC. The fact that is linear says that the total sample mass recovered at the detector is constant. The DCM 114 is functioning effectively, namely, by removing only sample-free carrier fluid without pulling sample material into the DCM port. The linearity confirms that the entire injected sample reaches the detector, even at high CE ratios, meaning that the DCM port 114 is well-positioned to remove only dilution fluid and that there is no sample mass lost to the DCM port, since the recovered mass relative to that of C=1 is nearly 1.0. This also shows that that the system 100 maintains quantitative accuracy, even with increasing CE and can enable high concentration enhancement without compromising sample recovery.

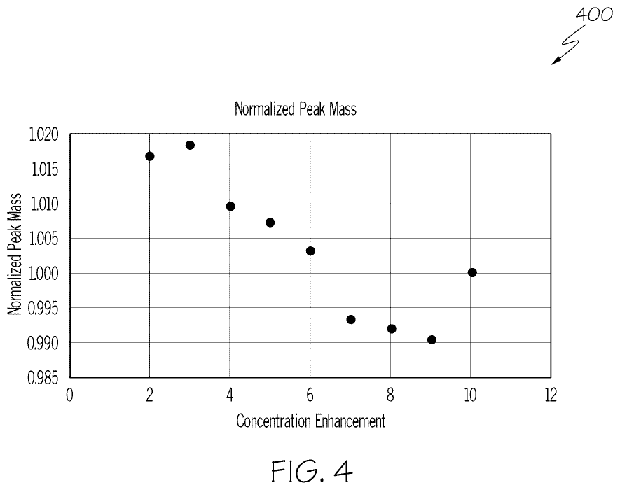

Another way of seeing that the mass recovery is constant is shown in FIG. 4 is a graph 400 which shows the data from FIG. 3 divided by the CE. The values stay close to 1.0, also indicating that no sample is lost to the DCM port 114, even at higher CEs.

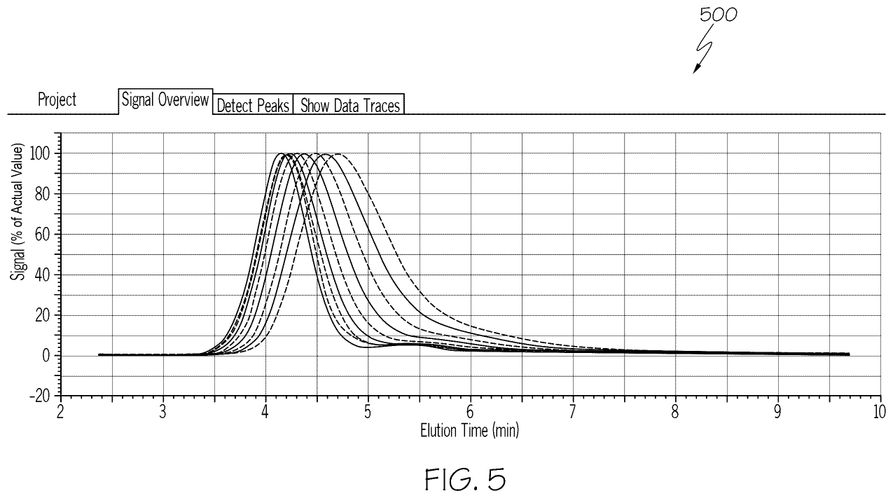

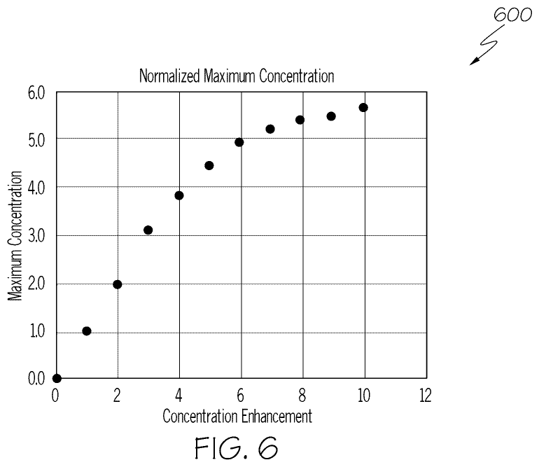

Although no mass is lost FIGS. 5 and 6 show that the runs at the highest CE ratios suffer from a loss of resolution. The graph 500 in FIG. 5 shows normalized chromatograms for a range of CE ratios from 2× to 10×. Each curve is normalized to unit height, meaning all peaks have the same maximum height in the graph, regardless of absolute concentration.

At high CE ratios, the width of the peaks increases. This means that peak resolution is degraded. Also, the peak shifts to the right indicating that it takes longer for the sample to elute. This also indicates a slower flow or increased transit time between the DCM 114 and detector outlet port 112.

This effect is even more clear when the maximum concentration for each CE ratio is plotted as shown in FIG. 6. If the effect of the DCM were to only increase the peak height, then the maximum concentration would scale proportional to CE like the peak area does. FIG. 6 shows that for low CE ratios (<˜5), the concentration does grow linearly. Above CE˜5, it begins to plateau. This indicates that peak broadening is counteracting the expected increase in concentration. Therefore, while total sample mass increases with CE (see FIG. 3), the maximum concentration (peak height) does not scale linearly at high CE values, limiting the useful range of the technique.

In brief overview, embodiments of the present inventive concept address the foregoing by presenting an optimized channel design that minimizes the broadening and allows one to achieve higher maximum concentration enhancements. An unequivocal hallmark of a superior design is if, at any given concentration enhancement setting, the peak concentration is increased. A perfect system would have the maximum concentration scale linearly with CE. The closer that any given realization gets to linearity, the better. To achieve this, the DCM port and detector outlet port geometry and spacing are optimized to allow operation at higher CE ratios while minimizing resolution loss.

As described above to achieve the full benefit of the concentration enhancement, it is important to ensure that the DCM port 114 only collect a source of sample-free solvent and that the detector outlet port 112 collect the remainder, which may include a combination of solvent and sample.

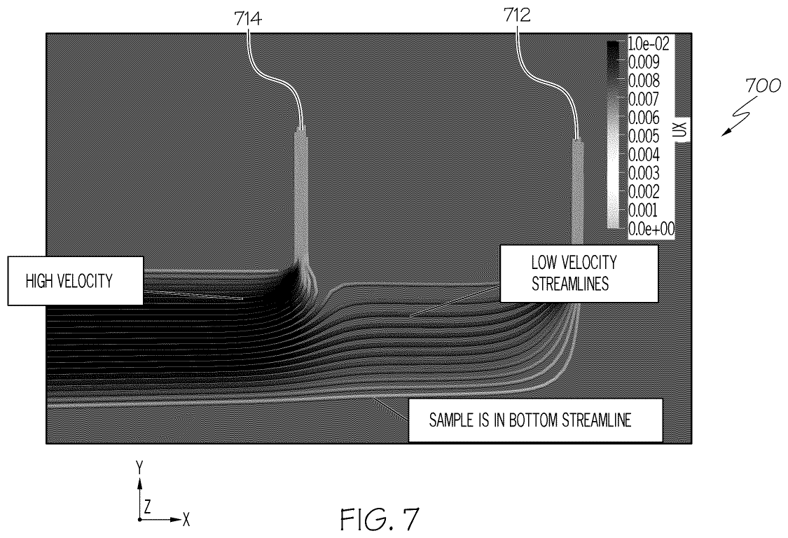

FIG. 7 is a computational fluid dynamics (CFD) simulation 700 illustrating how sample and solvent flow through the output region of a field-flow fractionation (FFF) channel when using a 5:1 split ratio between a DCM port 714 and a detector outlet port 712 of a FFF channel, similar to or the same as the FFF channel 103 shown and described with reference to FIG. 1. FIG. 7 illustrates why high CE ratios cause peak broadening and resolution loss.

Shown in simulation 700 are flow streamlines in the FFF channel that represent the paths that fluid elements follow from the channel toward either the DCM 714 or outlet port 712. The streamlines indicate fluid motion. The color blue indicates low velocity, and red indicates high.

The FFF separation occurs very close to the accumulation wall. In this simulation the sample is confined to the streamline near the accumulation wall (bottom). The DCM 714 Pulls Carrier Fluid (Not Sample). The DCM port 714 is drawing fluid from upper streamlines, which consist of carrier solvent only. This validates the dilution control concept: removing sample-free solvent without pulling sample. Because the DCM is drawing 80% of the total flow (5:1 ratio), there is a velocity drop between the ports 712, 714, i.e., the streamlines between the two ports slow down, shown by the low velocity streamlines in the white region, referred to as a slow zone. This slow-moving region between the DCM 714 and outlet port 712 leads to diffusive mixing and shear. As the sample passes through this low-velocity zone it broadens due to diffusion. The delayed elution is due to the reduced velocity between port 714 and 714, which was shown in FIGS. 5 and 6.

Referring again to the brief overview, embodiments of the present inventive concept can eliminate the problems caused by the slow flow zone by modifying the spacing between the ports 712, 714 and/or adding barriers between the ports.

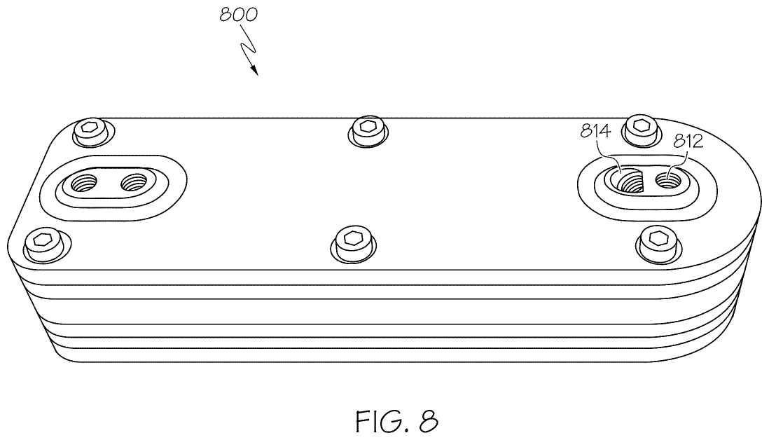

FIG. 8 depicts an apparatus 800 in accordance with some embodiments. In some embodiments, the apparatus is a field flow fractionator, or more specifically, a separation mechanism constructed to perform an asymmetric-flow field-flow fractionation (AF4) separation process.

In some embodiments, the distance, or region of separation, between the channel outlet port 812 and a DCM port 814 is about 4-5 mm, or no greater than 5 mm, for example, 4.68 mm but not limited thereto. This distance may be determined by center-to-center distance, namely, from a center of the DCM port 814 to a center of the channel outlet port 812. Conventional FFF channels have a larger separation, for example, 11 mm. The smaller separation allows less delay and less peak broadening between ports, improving signal resolution in high CE configurations. The apparatus 800 allows the DCM to still collect solvent without pulling in sample, while reducing the transit time and diffusion effects that degrade peak resolution, resulting in better performance metrics than those found in conventional FFF devices.

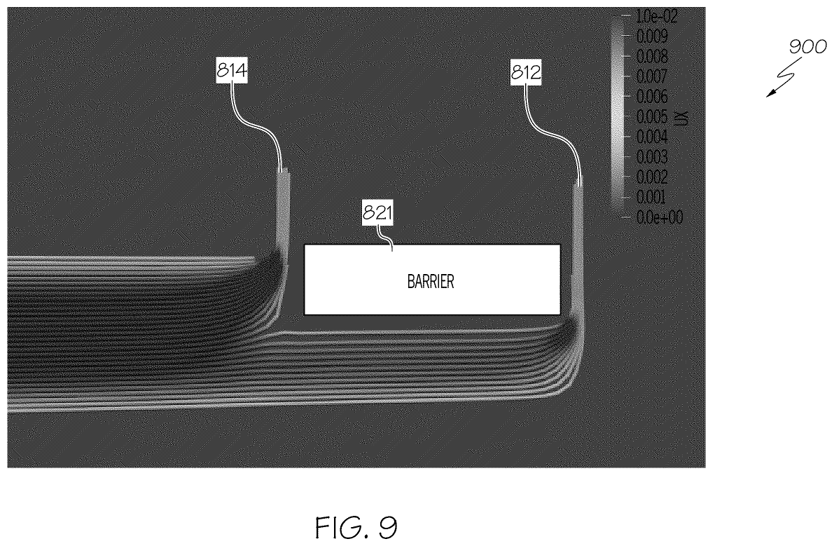

FIG. 9 illustrates one embodiment of the apparatus 800 of FIG. 8, or more specifically, CFD simulation 900 taken of the apparatus 800. Here, the apparatus 800 includes an exit barrier 821 between the channel outlet port 812 and a DCM port 814. The barrier 821 is constructed and arranged to partially fill the vertical space between the top and bottom plates in the FFF (Field-Flow Fractionation) channel. In some embodiments, at least a portion of an opening of the DCM port 814 is positioned on a plane lower than the plane of the stepped barrier 821. In some embodiments, the separation channel is machined into the top plate 804, which offers a construction permitting the addition of the barrier 821. In doing so, the barrier 821 constricts the flow path between the ports 812, 814. Thus, the presence of the barrier 821 forces the fluid between the two ports 812, 814 to be confined to a narrow channel, which increases its linear fluid velocity. When compared to the graph 600 in FIG. 6, it is clear that the fluid between the ports moves more rapidly and will therefore be delayed less than without the presence of the barrier. In some embodiments, the barrier 821 in FIG. 9 is a stepped barrier since the top plate 804 is not flat due to the presence of the barrier 821.

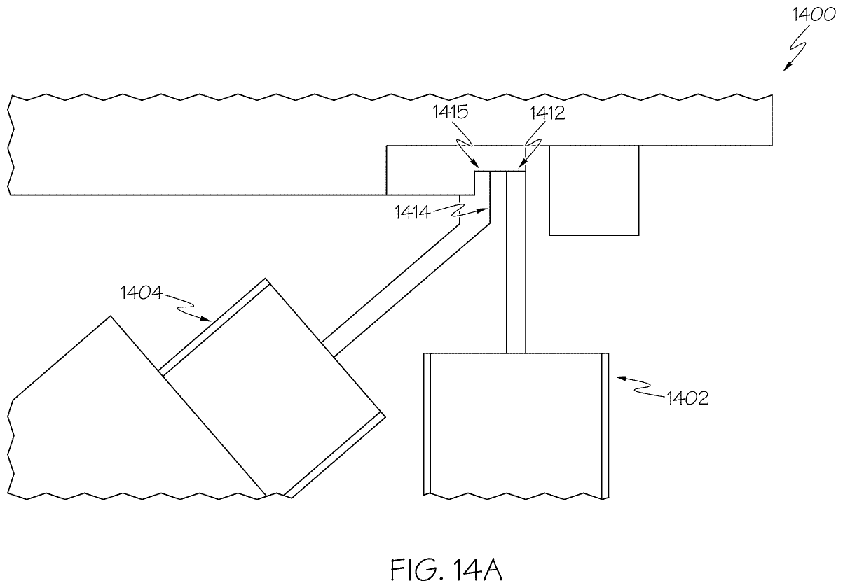

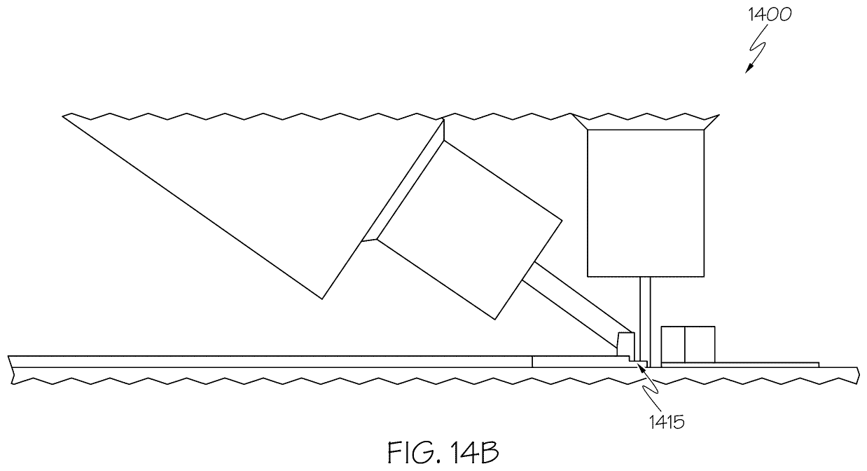

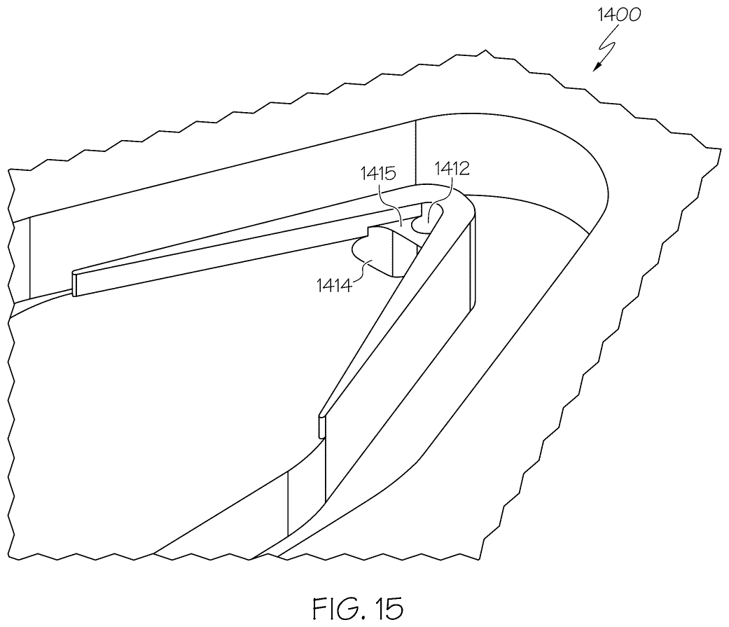

FIGS. 14A-15 illustrate an embodiment of an apparatus 1400 having a stepped barrier 1415. Other elements of the apparatus 1400 such as a sample outlet port 1412, DCM port 1414, and fittings 1402, 1404 may be similar to or the same as those of other embodiments described herein so details are not repeated for brevity. The top plate 1404 of the apparatus 1400 has a machined channel and barrier as shown. FIG. 15 is a perspective view that is inverted to illustrate the stepped barrier 1415 as compared to the views in FIGS. 14A and 14B.

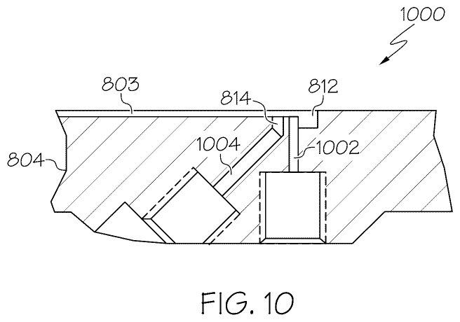

FIG. 10 is a cross-sectional view illustrating another embodiment.

As shown in FIG. 10, the DCM port 814 receives fluid via a fitting or fluid connection 1004 that is at an angle relative to the FFF channel 803. The angle refers to the orientation of the fitting or fluid connection 1004 for the DCM port 814 relative to the surface of the top plate 804, which has the channel 803 machined therein. The apparatus 800 is shown as inverted. A membrane (not shown) can be positioned over the channel 803.

The angle is relevant in that it permits close spacing between the ports 812, 814 without interference. It is desirable to position the DCM port 814 as close as possible to the detector outlet port 812 consistent with not causing any of the sample exiting port 812 to mix with the DCM flow in 814. The angle permits the ports 812, 814 to be spaced to less than 2 mm, e.g., 1.2 mm apart, but not limited thereto. In some embodiments, the DCM port 814 has a width of 1 mm, but not limited thereto. By angling the DCM port fitting 1004, the design preserves tight port spacing while still allowing room for tubing or connectors. A steep angle, e.g., >30°, allows easier access with standard tools and improves manufacturability and assembly. It also allows tubing to connect cleanly without needing excessive bending. It also preserves fluidic functionality because the distance that a sample must travel is reduced. Therefore, the transit time is reduced correspondingly. The angle is sufficiently steep that the port 812 still effectively draws fluid from the correct vertical layer (i.e., solvent-rich top layer), without intruding into the sample zone. A tilted fluid path formed by the fitting 1004 still allows the port opening 814 to be flush with the channel wall where needed.

As described above, some embodiments include an angle of the DCM port fitting 1004 is greater than 30 degrees to allow for the distance between the ports 812, 814. This ensures that the DCM port 814 can be positioned very close to the outlet port 812 and that fittings 1002, 1004 can be mounted to the ports 812, 814, respectively, without physical interference. See for example the threaded fittings 1002, 1004 for fluid connectors.

The system retains high-performance fluid handling. Accordingly, the angle of the DCM port fitting is crucial because it enables the tight physical spacing needed for effective dilution control—without sacrificing accessibility or assembly practicality while providing a high concentration enhancement with minimal resolution loss by minimizing peak broadening and sample dispersion.

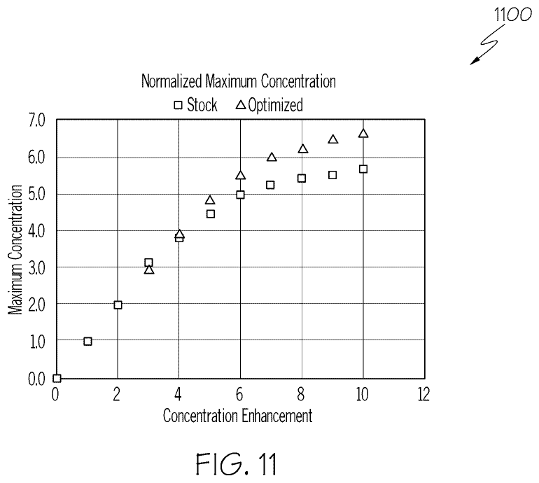

The graph 1100 in FIG. 11 shows a comparison of the maximum normalized concentration detected for different Concentration Enhancement (CE) ratios using the apparatus 800 shown in FIG. 10 as compared to a conventional fixed height (FH) channel configuration. The X-axis includes a range of CE ratios (e.g., 2×, . . . 10×).

As shown, the apparatus 800 shown in FIG. 10 consistently produces taller peaks (higher concentration signals) than the conventional FH channel for the same CE value. Also, shown is an improved high-CE performance offered by the apparatus 800 shown in FIG. 10. At high CE (e.g., 8×-10×), the conventional FH channel performance plateaus at a lower height than the apparatus 800 shown in FIG. 10, which continues to increase, showing it preserves resolution better even under demanding CE settings without the resolution loss that limits current channel designs.

The graph 1200 plots the normalized peak area (integrated UV signal) across CE values for both the apparatus 800 shown in FIG. 10 and conventional FE channel design. As shown, the normalized peak areas are nearly identical for both designs across all CE values. The peak area remains proportional to CE, indicating no significant sample loss in either design. Identical areas mean both designs recover the same amount of analyte—the apparatus 800 shown in FIG. 10 doesn't lose sample to the DCM port, even though the ports are closer together, namely, less than 5 mm, e.g., 1.2 mm. Thus, the apparatus 800 shown in FIG. 10 improves concentration performance without sacrificing recovery efficiency, i.e., maintaining mass recovery as shown by the equivalent mass recovery as the conventional design.

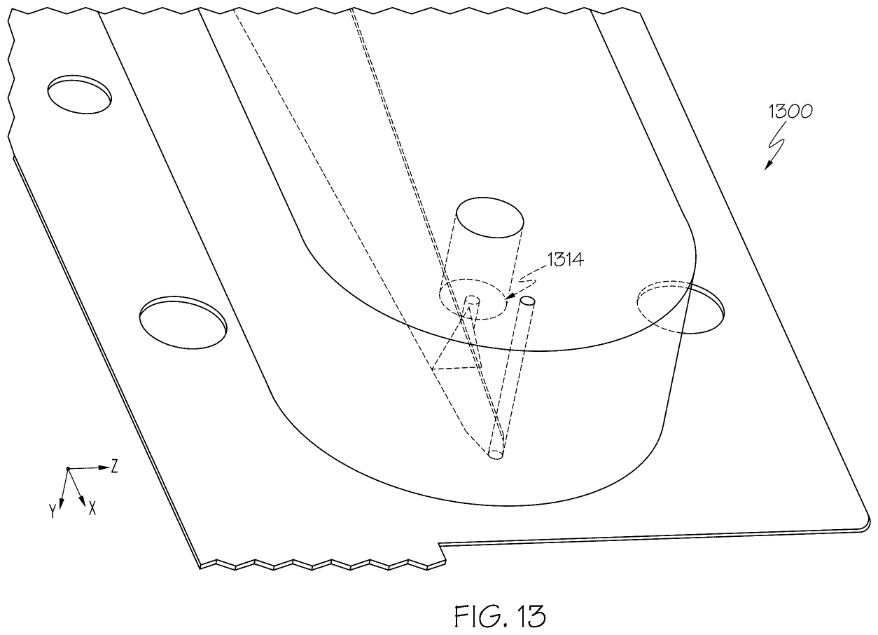

FIG. 13 is a perspective view of a DCM 1300 comprising a flat conical shape, in accordance with some embodiments.

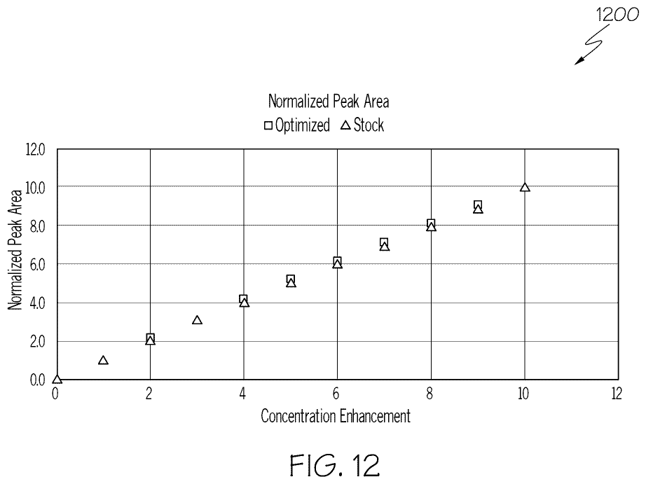

The flat cone design facilitates smoother and more directed fluid flow into the DCM port 1314. It minimizes turbulence, reducing the potential for sample loss or mixing at the exit. The conical shape helps in fitting the DCM port closer to the outlet port, e.g., shown in FIG. 10, maintaining a small footprint while optimizing performance. By ensuring that the sample stream near the accumulation wall is not entrained into the DCM, it preserves resolution and peak concentration without significant sample loss, especially at high Concentration Enhancement (CE) values, as shown in the graphs in FIGS. 11 and 12.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A field flow fractionator comprising:
a top plate comprising:
a channel side;
a fitting side;
a channel outlet port; and
a dilution control module (DCM) port,
wherein the DCM port is positioned a predetermined distance from the channel outlet port on the channel side of the top plate,
wherein an opening of the DCM port comprises a slot with a height to span a channel from a first edge of the channel to a second edge of the channel and with a width to allow for the distance, and
wherein a fitting of the DCM port extending through the top plate is positioned at an angle relative to a direction of extension of the top plate to accommodate the predetermined distance.

2. The field flow fractionator of claim 1 wherein the distance is less than 4.68 mm.

3. The field flow fractionator of claim 2, wherein the DCM port and the channel outlet port are separated by 1.20 mm.

4. The field flow fractionator of claim 1 wherein the width is less than 1.5 mm.

5. The field flow fractionator of claim 4, wherein the DCM port has a slot width of 1 mm.

6. The field flow fractionator of claim 1 wherein the angle is greater than 30 degrees to allow for the distance.

7. The field flow fractionator of claim 1 wherein the DCM port further has a conical shape.

8. A field flow fractionator (FFF) comprising:
a top plate comprising:
a stepped barrier;
a channel outlet port, wherein an opening of the channel outlet port is positioned on a plane of the stepped barrier; and
a dilution control module (DCM) port,
wherein at least a portion of an opening of the DCM port is positioned on a plane lower than the plane of the stepped barrier.

9. The field flow fractionator of claim 8, further comprising a separation channel machined into the top plate.

10. The field flow fractionator of claim 9, further comprising a tilted fluid port extending from the separation channel to the DCM port.

11. An apparatus, comprising:
a top plate comprising:
a top surface; and
a bottom surface;
a bottom plate;
a field flow fractionation channel between the top plate and the bottom plate;
a channel outlet port; and
a dilution control module (DCM) port,
wherein the DCM port is positioned a predetermined distance from the channel outlet port on a channel side of the top plate,
wherein an opening of the DCM port comprises a slot with a height to span a channel from a first edge of the channel to a second edge of the channel and with a width to allow for the distance, and
wherein a fitting of the DCM port extending through the top plate is positioned at an angle relative to a direction of extension of the top plate to accommodate the predetermined distance.

12. The apparatus of claim 11, further comprising a barrier element between the DCM port and the channel outlet port.

13. The apparatus of claim 12, wherein the barrier prevents the bottom surface of the top plate from being flat.

14. The apparatus of claim 11, wherein the channel is machined in the bottom surface of the top plate.

15. The apparatus of claim 11, wherein DCM port has a flat conical shape.
